(19) United States
(12) Patent Application Publication
(10) Pub. No.: US 2025/0373918 A1
(43) Pub. Date: Dec. 4, 2025

(54) IMAGE CAPTURING APPARATUS INCLUDING IMAGE BLUR CORRECTION MECHANISM AND HEAT DISSIPATION STRUCTURE

(71) Applicant: CANON KABUSHIKI KAISHA, Tokyo (JP)

(72) Inventor: TAKASHI MIYAZAKI, Tokyo (JP)

(21) Appl. No.: 19/216,058

(22) Filed: May 22, 2025

(30) Foreign Application Priority Data
May 31, 2024 (JP) 2024-088623

(51) Int. Cl. H04N 23/52; H04N 23/68

(52) U.S. Cl. CPC H04N 23/52; H04N 23/687

(57) ABSTRACT

An image capturing apparatus includes a movable part equipped with an image sensor, a fixed part supporting the movable part in a state movable within a plane orthogonal to a photographing optical axis, and a heat dissipation member connecting between the movable part and the fixed part. The heat dissipation member includes a first main fixed area fixed to the movable part, a second main fixed area fixed to the fixed part, and a connection portion that connects between the first main fixed area and the second main fixed area. The first main fixed area and the second main fixed area are orthogonal to the photographing optical axis, respectively. The connection portion has at least one first bent portion disposed in a space formed between the movable part and the fixed part in a direction parallel to the photographing optical axis.

### BACKGROUND

### Field of the Technology

The present disclosure relates to an image capturing apparatus including an image blur correction mechanism and a heat dissipation structure.

### Description of the Related Art

In an image capturing apparatus, such as a digital still camera and a video camera, an image sensor, such as a CMOS sensor, generates heat during operation. Therefore, a cooling mechanism is provided inside the image capturing apparatus so as to prevent the temperature of the image sensor from exceeding an operation-guaranteed temperature. Further, an image capturing apparatus has become popular which is equipped with an image blur correction mechanism that corrects an image blur by displacing an image sensor within a plane orthogonal to a photographing optical axis to improve image quality.

To the image capturing apparatus equipped with this image blur correction mechanism, a cooling mechanism that efficiently cools the image sensor without increasing a driving load during image blur correction driving is required. To meet the requirement, PCT International Patent Publication No. WO2020/202811 discloses a technique in which a thickness direction of a bendable heat transfer member, which connects between a movable part and a fixed part of the image blur correction mechanism, is set to a direction orthogonal to the photographing optical axis to thereby reduce a driving load generated when driving the movable part of the image blur correction mechanism. Further, Japanese Patent Laid-Open Patent Publication No. 2021-189225 discloses a technique for reducing an influence of a heat transfer member on the driving load by determining a location where the movable part passes during image blur correction driving.

In the technique disclosed in PCT International Patent Publication No. WO2020/202811, since the thickness direction of the heat transfer member is set to the direction orthogonal to the photographing optical axis, to increase the heat transfer amount, it is required to increase the number of heat transfer members or increase the width of each heat transfer member. However, as a result of this increase, the driving load generated when executing driving image blur correction that displaces the movable part having the image sensor can be increased, and further, the image blur correction mechanism can be increased in size. Further, in the technique disclosed in Japanese Patent Laid-Open Patent Publication No. 2021-189225, since the location where the movable part passes is determined, the responsiveness of image blur correction is lowered.

### SUMMARY

The present disclosure is directed to provide an image capturing apparatus that is capable of obtaining sufficient cooling performance for an image sensor without hindering driving control of image blur correction.

In a first aspect of the present disclosure, there is provided an image capturing apparatus including a movable part including an image sensor, a fixed part supporting the movable part in a state movable within a plane orthogonal to a photographing optical axis, and a heat dissipation member connecting between the movable part and the fixed part, wherein the heat dissipation member includes a first main fixed area that is fixed to the movable part, a second main fixed area that is fixed to the fixed part, and a connection portion that connects between the first main fixed area and the second main fixed area, wherein the first main fixed area and the second main fixed area are orthogonal to the photographing optical axis, and wherein the connection portion has at least one first bent portion disposed in a space formed between the movable part and the fixed part in a direction parallel to the photographing optical axis.

In a second aspect of the present disclosure, there is provided an image capturing apparatus including a movable part including an image sensor, a fixed part supporting the movable part in a state movable within a plane orthogonal to a photographing optical axis, and a heat dissipation member connecting between the movable part and the fixed part, wherein the heat dissipation member includes a first main fixed area that is fixed to a first surface, orthogonal to the photographing optical axis, of the movable part, a second main fixed area that is fixed to a second surface, orthogonal to the photographing optical axis, of the fixed part, and a connection portion that connects between the first main fixed area and the second main fixed area, wherein the movable part and the fixed part are arranged with a predetermined space such that the first surface and the second surface are substantially parallel to each other, wherein the first surface is a surface of the movable part, which is opposite from a surface opposed to the fixed part, wherein the second surface is a surface of the fixed part, which is opposite from a surface opposed to the movable part, wherein the connection portion is bent at least once after extending from the first main fixed area over a first side surface, parallel to the photographing optical axis, of the movable part, and then in a direction orthogonal to the first side surface in the space, extends toward a second side surface, parallel to the photographing optical axis, of the fixed part, and after further extending over the second side surface, connects to the second main fixed area, and wherein the first side surface and the second side surface are substantially parallel to each other on a plane projected from a direction of the photographing optical axis and are close to each other.

According to the present disclosure, it is possible to obtain sufficient cooling performance for the image sensor without hindering driving control of image blur correction.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram showing a configuration of an image capturing system according to embodiments.

FIG. 2 is an exploded perspective view of an image capturing apparatus as a component of the image capturing system.

FIGS. 3A and 3B are exploded perspective views of an image capturing unit arranged inside the image capturing apparatus.

FIG. 4 is a perspective view showing a heat dissipation member according to a first embodiment and its vicinity.

FIG. 5 is a cross-sectional view showing the heat dissipation member according to the first embodiment and its vicinity.

FIG. 6 is a development view of the heat dissipation member according to the first embodiment.

FIGS. 7A and 7B are cross-sectional views each showing a heat dissipation member according to a second embodiment and its vicinity.

FIG. 8 is a development view of the heat dissipation member according to the second embodiment.

### DESCRIPTION OF THE EMBODIMENTS

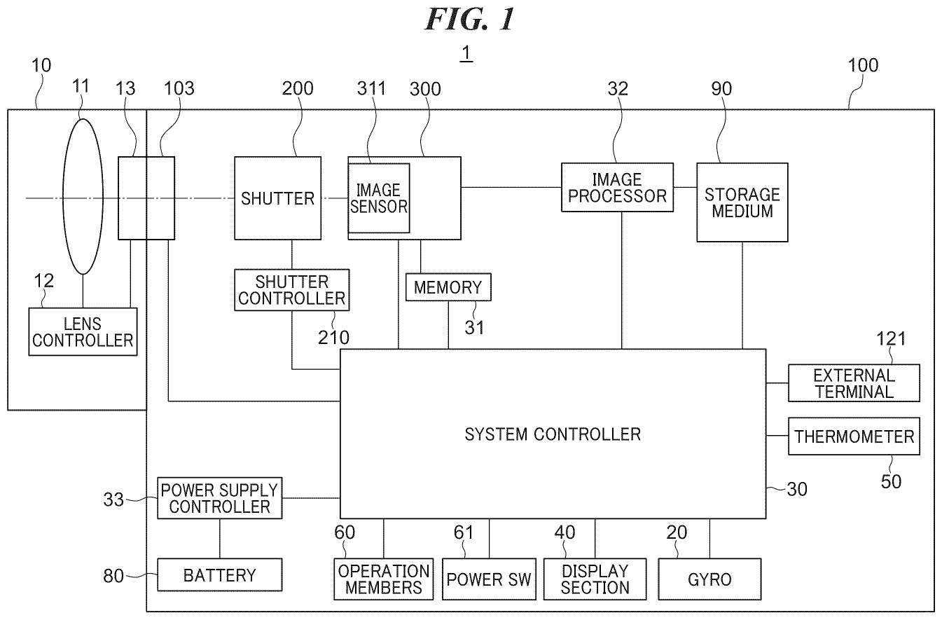

The present disclosure will now be described in detail below with reference to the accompanying drawings showing embodiments thereof. FIG. 1 is a block diagram showing a schematic configuration of an image capturing system 1 according to embodiments. The image capturing system 1 is roughly comprised of an image capturing apparatus 100 and a lens device 10 which can be removably attached to the image capturing apparatus 100. Here, a so-called lens-interchangeable digital still camera will be described as the image capturing apparatus 100.

The image capturing apparatus 100 includes a lens mount 103, a shutter 200, a shutter controller 210, an image capturing unit 300, an image processor 32, a system controller 30, a memory 31, a power supply controller 33, a battery 80, an external communication terminal 121, and a thermometer 50. Further, the image capturing apparatus 100 includes operation members 60, a power switch 61, a display section 40, a gyro sensor 20, and a storage medium 90. The image capturing unit 300 has an image sensor 311 and an image blur correction mechanism. The lens device 10 includes a lens 11, a lens controller 12, a diaphragm (not shown), and a camera mount 13.

The lens mount 103 is a member for attaching/detaching the lens device 10 (camera-side mount). When the lens device 10 is attached to the lens mount 103, electrical contacts provided on the lens mount 103 and the camera mount 13 (lens-side mount) of the lens device 10, respectively, are connected, whereby communication and power supply between the lens controller 12 and the system controller 30 are enabled. The shutter 200 controls an amount of exposure to the image sensor 311 by opening and closing operations. Light incident through the lens device 10 is guided to the image sensor 311 through the shutter 200 and forms an image on an imaging surface of the image sensor 311.

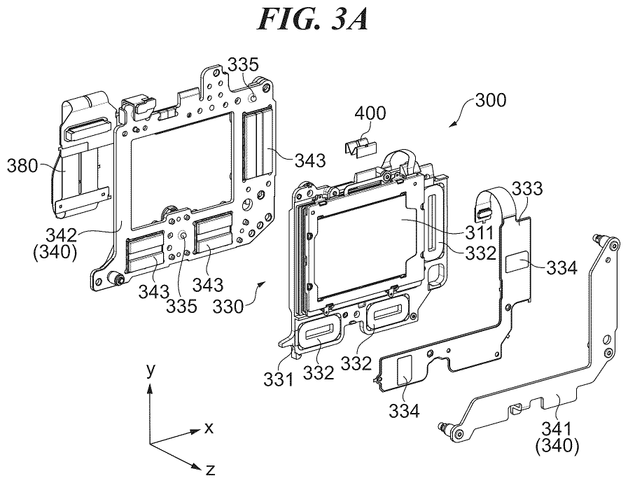

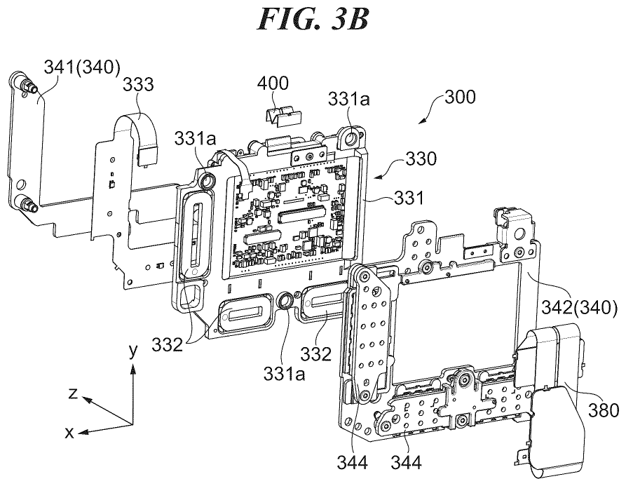

In the image capturing unit 300, the image sensor 311 converts the optical image formed on the imaging surface into analog electrical signals (image capturing signals) and sends the image capturing signals to the image processor 32. The image processor 32 generates, after converting the image capturing signals sent from the image sensor 311 to digital signals, image data by performing predetermined image processing on the digital signals, and writes the generated image data into the storage medium 90. Note that the image processor 32 also generates image signals to be displayed on the display section 40 from image data read out from the storage medium 90. The image blur correction mechanism displaces (swings or moves) a movable part 330 (see FIGS. 3A and 3B) equipped with the image sensor 311 within a plane orthogonal to a photographing optical axis (within a plane parallel to the imaging surface of the image sensor 311) according to an amount of shake detected by the gyro sensor 20. With this, it is possible to correct an image blur caused e.g. due to a hand shake.

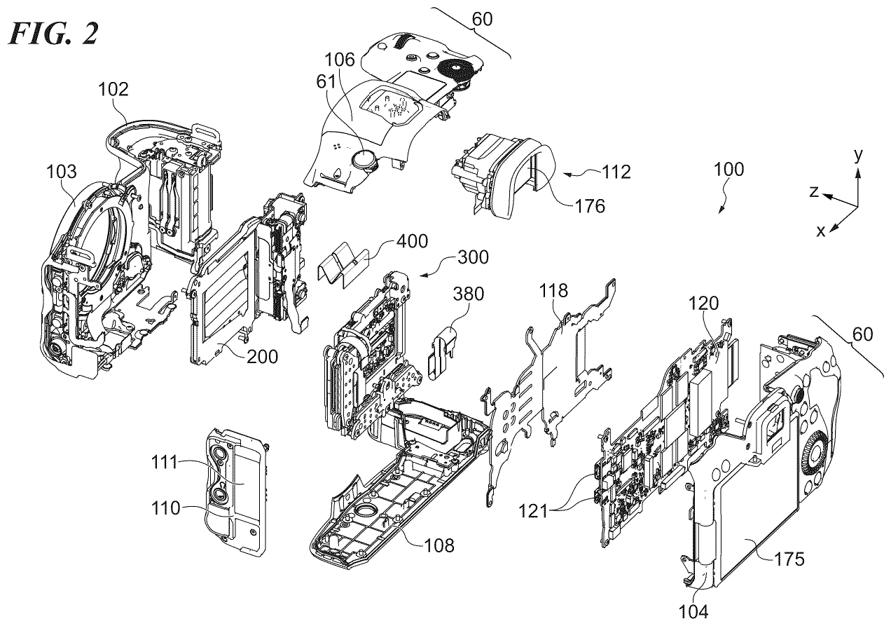

The system controller 30 is a microcomputer that controls the overall operation of the image capturing system 1. For example, the system controller 30 controls driving of the lens 11 and the diaphragm via the shutter controller 210 and the lens controller 12 based on a result of calculation performed by the image processor 32 on captured image data output from the image sensor 311 to perform AF processing and AE processing. The memory 31 is a storage medium, such as an EEPROM, which stores constants and variables for the operation of the system controller 30, programs, and so forth, and also stores a state of the image sensor 311 (position information of the movable part 330) displaced by the image blur correction mechanism. The display section 40 includes a vari-angle type rear monitor 175 (see FIG. 2) and an electronic view finder (EVF) 176 (see FIG. 2) and displays a live view video, a captured image, a menu for making a variety of settings of the image capturing system 1, and so forth.

The thermometer 50 measures temperatures of a variety of heat generating components including the image sensor 311. The power switch 61 is an operation member for switching power-on/off of the image capturing apparatus 100. The operation members 60 refer to a variety of buttons, a switch, a dial, and so forth, other than the power switch 61, and are used to select a function and make settings for executing photographing, image reproduction, communication, and so forth. The gyro sensor 20 detects an amount of image blur of the image capturing apparatus 100. The power supply controller 33 is comprised of a battery detection circuit, a DC/DC converter, and a switching circuit for switching a block to be energized, detects a type and a remaining amount of the battery 80, and supplies necessary voltage to the components for a necessary time period based on a result of detection and an instruction from the system controller 30.

The lens device 10 is a so-called interchangeable lens. The lens 11 is formed by a plurality of lenses, such as a focus lens, a zoom lens, and an image blur correction lens. The lens controller 12 controls the operations of the components of the lens device 10 according to a command from the system controller 30. The camera mount 13 is configured to be attachable/detachable to and from the lens mount 103. The diaphragm adjusts an amount of incident light to the image sensor 311.

FIG. 2 is an exploded perspective view of the image capturing apparatus 100. As exterior members, the image capturing apparatus 100 has a front base 102, a rear cover 104, a top cover 106, a bottom cover 108, and a side cover 110. Inside the casing formed by these exterior members, the image capturing unit 300, a printed circuit board 120, the shutter 200, and a chassis 118 are arranged. Note that an x-axis, a y-axis, and a-z axis, which are orthogonal to each other, are defined as illustrated in FIG. 2. The z-axis is parallel to the photographing optical axis, and when the x-axis and the z-axis are within a horizontal plane, the y-axis is parallel to the vertical direction, and in this state, the image capturing apparatus 100 is defined to be in a normal posture. Note that the x direction is the width direction of the image capturing apparatus 100, the y direction is the height direction of the image capturing apparatus 100, and the z direction is the front-rear direction of the image capturing apparatus 100.

The front base 102 is molded by magnesium die cast and resin. The lens mount 103 to which the lens device 10 is attached is fixed to the front base 102, and further, the front base 102 is formed with a grip part used by a user to grip the image capturing apparatus 100. The rear cover 104 is provided with the plurality of operation members 60 and the vari-angle-type rear monitor 175. Note that to the rear cover 104, a finder unit 112 is attached, which includes the EVF 176 used by a user to look into an object.

The top cover 106 is provided with the plurality of operation members 60. The bottom cover 108 has a battery chamber accommodating the battery 80 and a tripod mount for fixing the image capturing apparatus 100 to a tripod. The side cover 110 is provided with a terminal cover 111 for protecting the external communication terminal 121 mounted on the printed circuit board 120.

On the printed circuit board 120, the are mounted not only the external communication terminal 121, but also various types of electronic components, such as the electronic elements that function as the system controller 30 and the image processor 32 and a connector for attaching the storage medium 90. The printed circuit board 120 is fixed to the front base 102 and the chassis 118, made of metal, with screws. The image capturing unit 300 and the printed circuit board 120 are electrically connected to each other by a flexible circuit board 380, and the image capturing signals output from the image sensor 311 are transmitted to the printed circuit board 120 via the flexible circuit board 380.

Out of the internal components of the image capturing apparatus 100, the image sensor 311 is particularly large in power consumption, and its temperature easily rises during operation. To suppress degradation of image quality of a captured image, it is necessary to maintain the temperature of the image sensor 331 not higher than the operation-guaranteed temperature. The image capturing unit 300 is fixed to the front base 102 with screws, and heat generated in the image sensor 311 is transferred to the front base 102. At this time, inside the image capturing unit 300, transfer of heat generated in the image sensor 311 is performed by using a heat dissipation member 400 according to a first embodiment.

Next, the configuration of the image capturing unit 300 including a heat dissipation path including the heat dissipation member 400 inside the image capturing unit 300 will be described. FIGS. 3A and 3B are exploded perspective views of the image capturing unit 300, which are different in the direction of viewing the image capturing unit 300 from each other.

The image capturing unit 300 has the movable part 330 and a fixed part 340. The fixed part 340 is formed by a front plate 341 and a rear plate 342, which are sheet metal members, and by fixing the rear plate 342 to the front base 102 with screws, the image capturing unit 300 is fixed inside the image capturing apparatus 100.

The movable part 330 is disposed between the front plate 341 and the rear plate 342 of the fixed part 340. The movable part 330 includes an image sensor board having the image sensor 331 mounted thereon and an image sensor holder 331 holding the image sensor board. A flexible circuit board 333 is connected to the image sensor board, and further, the heat dissipation member 400 is disposed to connect between the image sensor holder 331 and the rear plate 342.

The image sensor holder 331 is formed with ball holding portions 331a at three locations on its periphery, and balls 335 are sandwiched and held between the image sensor holder 331 and the rear plate 342 in the ball holding portions 331a. The movable part 330 is supported by the balls 335, which freely roll, in a state displaceable (i.e. swingable or movable) within a plane orthogonal to the photographing optical axis (z-axis) between the front plate 341 and the rear plate 342.

The rear plate 342 has magnets 343 arranged at three locations. The magnets 343 are stably fixed to the rear plate 342 by using fixing plates 344, respectively. On the other hand, coils 332 are fixed to the image sensor holder 331 in a state opposed to the magnets 343 in the photographing optical axis direction (z direction), respectively. Power supply to the coils 332 is performed by the flexible circuit board 333 connected to the image sensor board.

The magnets 343 and the coils 332 form a driving mechanism that makes the movable part 330 displaceable relative to the fixed part 340. That is, by supplying power to the coils 332 via the flexible circuit board 333, the movable part 330 is displaced by repulsive force and attractive force generated between magnetic fields generated around the coils 332 and magnetic fields of the magnets 343. At this time, by controlling the magnitude of electric current supplied to each coil 332, it is possible to control a displacement direction and a displacement amount of the movable part 330 within the plane orthogonal to the photographing optical axis.

Note that the image blur correction mechanism is controlled such that the movable part 330 is kept in a photographing center position at the normal time, and is controlled to displace the movable part 330 in a direction of canceling an image blur of the image capturing apparatus 100, which is caused by a photographer when photographing is performed. Further, metal plates 334 are arranged in front of the coils 332 in the movable part 330, and the metal plates 334 and the magnets 343 are attracted by magnetism, whereby the image sensor holder 331 is positioned relative to the rear plate 342 across the balls 335 in the photographing optical axis direction. Thus, the image sensor 311 is positioned in a predetermined flange back position inside the image capturing apparatus 100.

The heat dissipation member 400 has a laminated structure formed e.g. by a PET film (sheet) and a graphite sheet. Heat generated in the image sensor 311 is transferred from the image sensor board and the image sensor holder 331 to the rear plate 342 via the heat dissipation member 400 and further transferred from the rear plate 342 to the front base 102 holding the rear plate 342. With this, the heat generated in the image sensor 311 is released to the outside, whereby it is possible to suppress temperature rise of the image sensor 311.

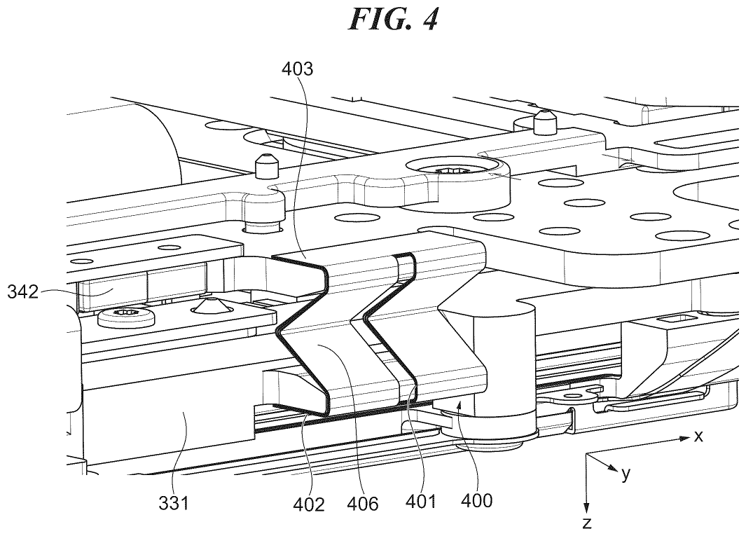

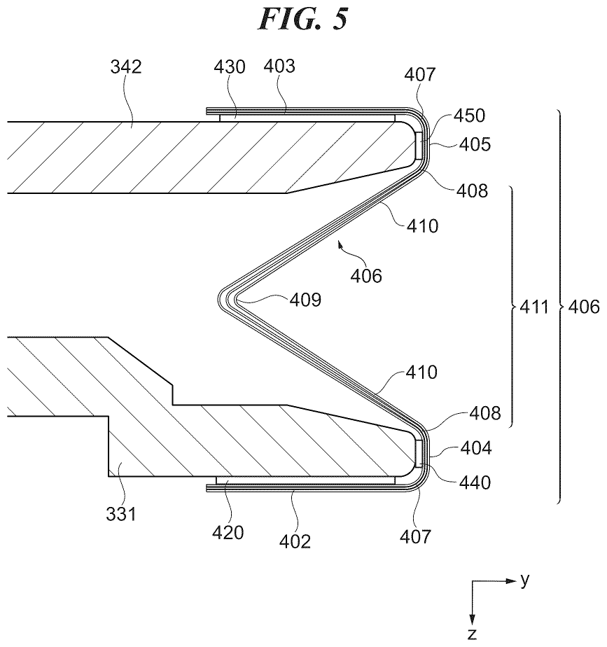

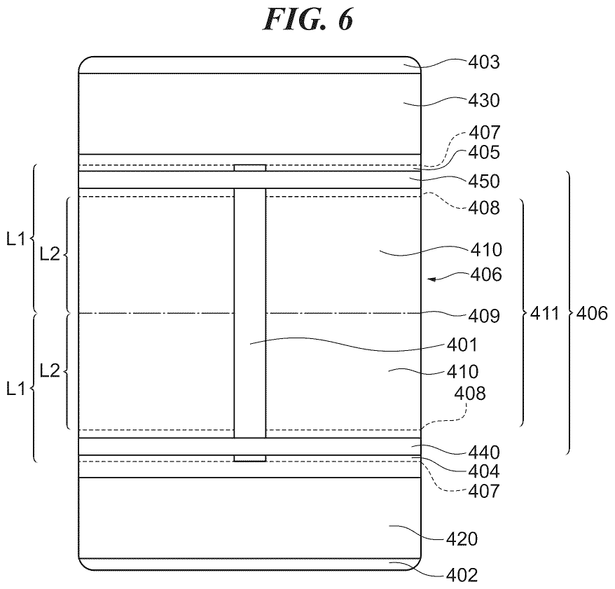

Next, the heat dissipation member 400 will be described in detail. FIG. 4 is a perspective view showing the heat dissipation member 400 and its vicinity in the image capturing unit 300. FIG. 5 is a cross-sectional view of the heat dissipation member 400. FIG. 6 is a development view of the heat dissipation member 400.

The heat dissipation member 400 is formed by a first movable part affixed area 402 as a main fixed area (first main fixed area) fixed to the movable part 330, a first fixed part affixed area 403 as a main fixed area (second main fixed area) fixed to the fixed part 340, and a connection portion 406 connecting between the first movable part affixed area 402 and the first fixed part affixed area 403. The heat dissipation member 400 is stuck and fixed to a flat surface portion of the first movable part affixed area 402, which is substantially orthogonal to the photographing optical axis, on a side, toward the front base 102, of the image sensor holder 331, with an adhesive double-coated tape 420. Further, the heat dissipation member 400 is stuck and fixed to a flat surface portion of the first fixed part affixed area 403, which is substantially orthogonal to the photographing optical axis, on a side, toward the rear cover 104, of the rear plate 342, with an adhesive double-coated tape 430.

The connection portion 406 has a first bent portion 409, second bent portions 407 arranged at two locations, third bent portions 408 arranged at two locations, a second movable part affixed area 404 as a sub fixed area fixed to the movable part 330, a second fixed part affixed area 405 as a sub fixed area fixed to the fixed part 340, and connection arm portions 410. The two second bent portions 407 are arranged between the first movable part affixed area 402 and the second movable part affixed area 404, and between the first fixed part affixed area 403 and the second fixed part affixed area 405. The two third bent portions 408 are arranged between the second movable part affixed area 404 and the second fixed part affixed area 405, and the respective connection arm portions 410, respectively.

Note that each bent portion refers to part having a fold, and is one form of a curved portion having a constant radius of curvature. Further, the bent portion has a bend property at the fold such that the bent state is held in its natural state.

The heat dissipation member 400 extending toward the outside of the image capturing unit 300 in the first movable part affixed area 402 and the first fixed part affixed area 403 at opposite ends is bent by the second bent portions 407 and the third bent portions 408, such that the connection arm portions 410 extend inward (leftward in FIG. 5) of the image capturing unit 300, and the connection arm portions 410 connect to the first bent portion 409. At this time, the second movable part affixed area 404 is stuck and fixed to a surface of the image sensor holder 331 (side surface of the image sensor holder 331, substantially parallel to the photographing optical axis), different from the surface to which the first movable part affixed area 402 is stuck, e.g. with an adhesive double-coated tape 440. Further, the second fixed part affixed area 405 is stuck and fixed to a surface of the rear plate 342 (side surface of the rear plate 342, substantially parallel to the photographing optical axis), different from the surface to which the first fixed part affixed area 403 is stuck, e.g. with an adhesive double-coated tape 450.

Thus, the heat dissipation member 400 is formed such that the connection arm portions 410 and the first bent portion 409 (hereinafter referred to as the “accommodated portion 411”) sandwiched between the third bent portions 408 are accommodated in a space formed between the image sensor holder 331 and the rear plate 342 in the photographing optical axis direction. Further, since the second movable part affixed area 404 and the second fixed part affixed area 405 are stuck to the image sensor holder 331 and the rear plate 342, respectively, the heat dissipation member 400 is prevented from unnecessarily expanding in a direction outward of the image capturing unit 300, which prevents increase in size of the image capturing unit 300.

Note that the second movable part affixed area 404 and the second fixed part affixed area 405 are arranged so as to obtain an effect of preventing the heat dissipation member 400 from unnecessarily expanding in the direction outward of the image capturing unit 300. Therefore, there is no problem even if the area size of each of the second movable part affixed area 404 and the second fixed part affixed area 405 is smaller than the area size of each of the first movable part affixed area 402 and the first fixed part affixed area 403.

As shown in FIG. 6, the shape of the heat dissipation member 400 in a flattened state is a substantially rectangular plate shape. To prevent the driving load from being increased by the heat dissipation member 400 in the image blur correction operation, the heat dissipation member 400 is formed with a slit 401 of which a longitudinal direction is a direction of connecting between the first movable part affixed area 402 and the first fixed part affixed area 403. Further, part of the heat dissipation member 400 except the slit 401 forms a heat transfer portion filled with the graphite sheet and the like.

To prevent load from being generated by contact between heat dissipation members on the long side of the slit 401, the width (the length in the x direction in FIG. 4 and the length in the right-left direction in FIG. 6) of the slit 401 is set to a value at which the heat transfer portions are not brought into contact with each other on the long side of the slit 401 when the image capturing unit 300 is displaced by the maximum amount. Further, the total length of the accommodated portion 411 in a direction of the length of the slit 401 is set to a value longer than the maximum displacement amount of the movable part 330 in the y direction. With this, even in a case where the image capturing unit 300 is displaced in the y direction by the maximum amount, the accommodated portion 411 is prevented from protruding outside the image capturing unit 300 (space between the image sensor holder 331 and the rear plate 342). For example, in a case where the accommodated portion 411 protrudes outside the image capturing unit 300 to be brought into contact with e.g. another component, the driving load can be increased by the contact, and further, a failure can be caused in the other component by heat transferred from the heat dissipation member 400 to the other component. Since the accommodated portion 411 is prevented from protruding outside the image capturing unit 300, it is possible to avoid occurrence of these problems.

Note that although the number of slits 401 is one in the present embodiment but it can be plural. In a case where a plurality of slits 401 are provided, the slits are formed to have the same width, whereby it is possible to make the driving load constant during image blur correction regardless of the position of the movable part 330, and hence it is possible to easily control driving of the image blur correction mechanism.

Next, the bent portions of the heat dissipation member 400 will be described in detail. In the heat dissipation member 400, a bend as a valley fold is formed on each second bent portion 407 and each third bent portion 408, a bend of a mountain fold is formed on the first bent portion 409, and the bent portions can maintain the bent state even in their free state. Therefore, even when image blur correction driving is performed, and further, an external force, such as impact, acts on the heat dissipation member 400, the heat dissipation member 400 can maintain its shape.

Further, as shown in FIG. 4, the heat dissipation member 400 is arranged such that the first movable part affixed area 402 and the first fixed part affixed area 403 are opposed to each other in the photographing optical axis direction (z direction). Further, as shown in FIG. 6, the two second bent portions 407 are each arranged at a location distant from the first bent portion 409 by a distance L1, and the two third bent portions 408 are each arranged at a location distant from the first bent portion 409 by a distance L2. Here, the distances L1 and L2 are set such that the first bent portion 409 is disposed at a location which is substantially the middle of the space formed between the image sensor holder 331 and the rear plate 342, and is close to an area connecting between the opposite ends of the heat dissipation member 400 in the photographing optical axis direction. Note that the opposite ends of the heat dissipation member 400 refer to respective ends of the first movable part affixed area 402 and the first fixed part affixed area 403, which are opposite (−y side in FIG. 4) from the connection portion 406.

By forming the heat dissipation member 400 such that it has the above-described structure that is symmetric with respect to the first bent portion 409 in the photographing optical axis direction, it is possible to realize the configuration in which the accommodated portion 411 is hardly brought into contact with the image sensor holder 331 and the rear plate 342 even during image blur correction driving. Further, the accommodated portion 411 is stable in a state extended inward of the image capturing unit 300 by the second bent portions 407 and the third bent portions 408, and hence it is possible to realize the configuration in which the heat dissipation member 400 is prevented from protruding outside the image capturing unit 300 even when impact is applied to the image capturing unit 300.

Note that the folding positions of the heat dissipation member 400 are not limited to the above-mentioned positions. For example, the heat dissipation member 400 can be formed such that the two third bent portions 408 are omitted, and the second movable part affixed area 404 and the second fixed part affixed area 405 are not included.

In the above-described embodiment, the image sensor holder 331 and the rear plate 342 are each formed into a substantially flat shape. Further, the first movable part affixed area 402 is provided on a surface (first surface), opposite from a surface opposed to the rear plate 342, of the image sensor holder 331. On the other hand, the first fixed part affixed area 403 is provided on a surface (second surface), opposite from a surface opposed to the image sensor holder 331, of the rear plate 342. Further, the image sensor holder 331 and the fixed part 340 are arranged with a predetermined space such that the first surface and the second surface are substantially parallel to each other. Then, the connection portion is extended from the first movable part affixed area 402 as the main fixed area (first main fixed area) fixed to the movable part 330 over a side surface (first side surface), substantially parallel to the photographing optical axis, of the image sensor holder 331, and then extended in the space formed between the image sensor holder 331 and the rear plate 342, in a direction orthogonal to the first side surface. Further, the connection portion is bent at least once in the space and then extended toward a second side surface, parallel to the photographing optical axis, of the rear plate 342. Here, on a plane projected from the photographing optical axis direction, the second side surface is substantially parallel to the first side surface and at the same time is close to the first side surface. Then, the connection portion is extended over the second side surface and connects to the first fixed part affixed area 403 as the main fixed area (second main fixed area) fixed to the fixed part 430. Note that it can be said that a heat dissipation member formed by providing the two third bent portions 408, the second movable part affixed area 404, and the second fixed part affixed area 405 in this configuration is the heat dissipation member 400 according to the first embodiment.

In this case, the effect of preventing the heat dissipation member from expanding outside the image capturing unit 300 is lowered, but it is possible to prevent the accommodated portion 411 from protruding outside the image capturing unit 300. Further, in a case where only the first bent portion 409, which is as small as possible, is formed as the bent portion, it is possible to simplify the process for manufacturing the heat dissipation member.

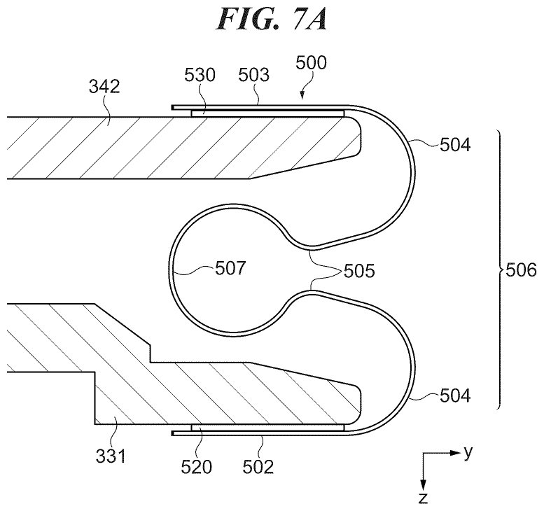

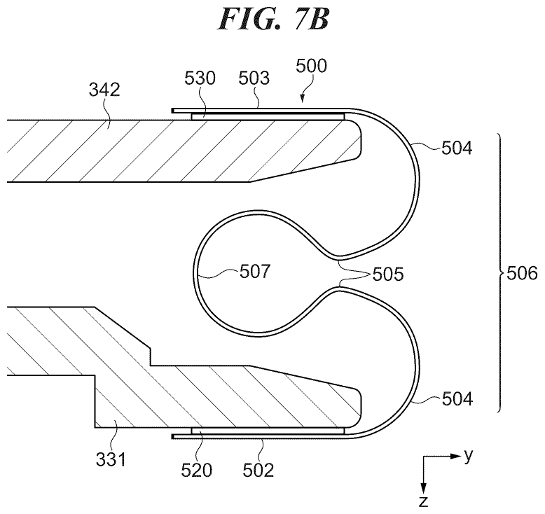

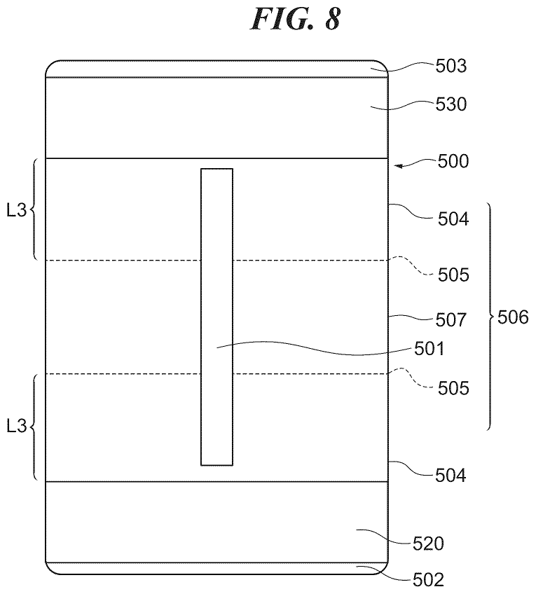

Next, a heat dissipation member 500 according to a second embodiment will be described. FIGS. 7A and 7B are cross-sectional views each showing the heat dissipation member 500 according to the second embodiment and its vicinity, in a form similar to FIG. 5. FIG. 7B shows a state in which the heat dissipation member 500 expands outward of the image capturing unit 300. FIG. 8 is a development view of the heat dissipation member 500.

The heat dissipation member 500 is formed by a first movable part affixed area 502, a first fixed part affixed area 503, and a connection portion 506. The connection portion 506 is formed by two curved connection arm portions 504 arranged at respective two locations, two bent portions 505 formed at respective end portions of the two connection arm portions 504, and a tubular portion 507 connecting between the two bent portions 505. The material forming the heat dissipation member 500 is the same as the material forming the heat dissipation member 400, and hence description thereof is omitted. Further, a slit 501 which is the same as the slit 401 formed in the heat dissipation member 400 is also formed in the heat dissipation member 500.

The first movable part affixed area 502 and the first fixed part affixed area 503 are stuck and fixed to a side, toward the front base 102, of the image sensor holder 331, and a side, toward the rear cover 104, of the rear plate 342, with e.g. adhesive double-coated tapes 520 and 530, respectively. One of the two connection arm portions 504 extends from the first movable part affixed area 502 inward (leftward in FIGS. 7A and 7B) of the image capturing unit 300 after extending over the side surface of the image sensor holder 331, and then connects to one of the bent portions 505. Similarly, the other one of the two connection arm portions 504 extends from the first fixed part affixed area 503 inward (leftward in FIGS. 7A and 7B) of the image capturing unit 300 after extending over the side surface of the rear plate 342, and connects to the other of the bent portions 505. At this time, the two bent portions 505 are arranged between the image sensor holder 331 and the rear plate 342 such that they are opposed to each other with a predetermined spacing in the photographing optical axis direction as the connection direction of the heat dissipation member 500. Further, the two bent portions 505 are connected by the tubular portion 507 in the space formed between the image sensor holder 331 and the rear plate 342. With this configuration, the connection portion 506 is prevented from expanding outside the image capturing unit 300.

Note that, similar to the bent portions 505, it is desirable that the connection arm portions 504 and the tubular portion 507 are given a bend property such that they are curved with a predetermined curvature. Further, the shape of the tubular portion 507 as viewed from the x direction in FIGS. 7A and 7B is not limited to a circular shape (annular shape) but for example, the tubular portion 507 can be formed into a polygon, such as an octagon.

Here, the two bent portions 505 are arranged at locations distant from the respective inside end portions of the first movable part affixed area 502 and the first fixed part affixed area 503 by a length L3. With this, the tubular portion 507 is arranged in the substantially middle position in the space formed between the image sensor holder 331 and the rear plate 342 in the connection direction (photographing optical axis direction) of the heat dissipation member 500. With this, even when an external force, such as impact, that displaces the heat dissipation member 500 outside the image capturing unit 300 is applied, the bent portions 505 are moved close to each other, which prevents the bent portions 505 and the tubular portion 507 from protruding outward of the image capturing unit 300.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-088623, filed May 31, 2024, which is hereby incorporated by reference herein in its entirety.

What is claimed is:

1. An image capturing apparatus comprising:
a movable part including an image sensor;
a fixed part supporting the movable part in a state movable within a plane orthogonal to a photographing optical axis; and
a heat dissipation member connecting between the movable part and the fixed part,
wherein the heat dissipation member includes:
a first main fixed area that is fixed to the movable part;
a second main fixed area that is fixed to the fixed part; and
a connection portion that connects between the first main fixed area and the second main fixed area,
wherein the first main fixed area and the second main fixed area are orthogonal to the photographing optical axis, and
wherein the connection portion has at least one first bent portion disposed in a space formed between the movable part and the fixed part in a direction parallel to the photographing optical axis.

2. The image capturing apparatus according to claim 1, wherein the heat dissipation member has a substantially rectangular plate shape when flattened, and
wherein the connection portion has a slit of which a longitudinal direction is a direction of connecting between the movable part and the fixed part.

3. The image capturing apparatus according to claim 1, wherein the first bent portion is close to an area connecting, in a direction parallel to the photographing optical axis, between an end, opposite from the connection portion, of the first main fixed area, and an end, opposite from the connection portion, of the second main fixed area, and at the same time is disposed in a substantially middle position of the space.

4. The image capturing apparatus according to claim 3, wherein the heat dissipation member has a structure that is substantially symmetrical with respect to the first bent portion.

5. The image capturing apparatus according to claim 1, wherein the connection portion includes two first bent portions each formed as the first bent portion at respective two locations, and a tubular portion having the two first bent portions as ends thereof, and
wherein the two first bent portions are opposed to each other with a predetermined spacing in a direction parallel to the photographing optical axis, and the tubular portion is disposed in a substantially middle position of the spacing in the direction parallel to the photographing optical axis.

6. The image capturing apparatus according to claim 1, wherein the first bent portion has a fold, and is maintained in a state bent at the fold in its natural state.

7. The image capturing apparatus according to claim 1, wherein the connection portion has a first sub fixed area fixed to a surface, different from a surface to which the first main fixed area is fixed, of the movable part, and a second sub fixed area fixed to a surface, different from a surface to which the second main fixed area is fixed, of the fixed part.

8. The image capturing apparatus according to claim 7, wherein in the heat dissipation member, the first main fixed area is fixed to a surface, substantially orthogonal to the photographing optical axis, of the movable part, the first sub fixed area is fixed to a surface, substantially parallel to the photographing optical axis, of the movable part, the second main fixed area is fixed to a surface, substantially orthogonal to the photographing optical axis, of the fixed part, and the second sub fixed area is fixed to a surface, substantially parallel to the photographing optical axis, of the fixed part.

9. The image capturing apparatus according to claim 7, wherein the first sub fixed area has an area size smaller than an area size of the first main fixed area, and the second sub fixed area has an area size smaller than an area size of the second main fixed area.

10. The image capturing apparatus according to claim 7, wherein in the connection portion, second bent portions are provided between the first main fixed area and the first sub fixed area and between the second main fixed area and the second sub fixed area, respectively.

11. The image capturing apparatus according to claim 10, wherein the connection portion includes third bent portions at respective opposed ends of the first sub fixed area and the second sub fixed area.

12. An image capturing apparatus comprising:
a movable part including an image sensor;
a fixed part supporting the movable part in a state movable within a plane orthogonal to a photographing optical axis; and
a heat dissipation member connecting between the movable part and the fixed part,
wherein the heat dissipation member includes:
a first main fixed area that is fixed to a first surface, orthogonal to the photographing optical axis, of the movable part;
a second main fixed area that is fixed to a second surface, orthogonal to the photographing optical axis, of the fixed part; and
a connection portion that connects between the first main fixed area and the second main fixed area,
wherein the movable part and the fixed part are arranged with a predetermined space such that the first surface and the second surface are substantially parallel to each other,
wherein the first surface is a surface, opposite from a surface opposed to the fixed part, of the movable part,
wherein the second surface is a surface, opposite from a surface opposed to the movable part, of the fixed part,
wherein the connection portion is bent at least once after extending from the first main fixed area over a first side surface, parallel to the photographing optical axis, of the movable part, and then in a direction orthogonal to the first side surface in the space, extends toward a second side surface, parallel to the photographing optical axis, of the fixed part, and after further extending over the second side surface, connects to the second main fixed area, and
wherein the first side surface and the second side surface are substantially parallel to each other on a plane projected from a direction of the photographing optical axis and are close to each other.
